(19) United States
(12) Patent Application Publication
(10) Pub. No.: US 2025/0330649 A1
(43) Pub. Date: Oct. 23, 2025

(54) METHOD AND APPARATUS FOR SIGNALING VIDEO USAGE FOR AI-DRIVEN PROCESSES IN SUPPLEMENTAL ENHANCEMENT INFORMATION MESSAGES

(71) Applicant: TENCENT AMERICA LLC, Palo Alto, CA (US)

(72) Inventors: Stephan WENGER, Palo Alto, CA (US); Arianne HINDS, Palo Alto, CA (US); Ying WANG, Palo Alto, CA (US)

(73) Assignee: TENCENT AMERICA LLC, Palo Alto, CA (US)

(21) Appl. No.: 19/180,618

(22) Filed: Apr. 16, 2025

Related U.S. Application Data
(60) Provisional application No. 63/635,960, filed on Apr. 18, 2024.

(51) Int. Cl. H04N 19/70

(52) U.S. Cl. CPC H04N 19/70

(57) ABSTRACT

There is provided a method for video encoding and video decoding based on a picture of a video and a Supplementary Enhancement Information (SEI) message associated with the picture of the video and including a syntax element indicative of whether a picture is allowed be used by an AI engine as an input.

### CROSS REFERENCE TO RELATED APPLICATION

The present application claims priority to provisional application U.S. 63/635,960 filed on Apr. 18, 2024, the contents of which are hereby expressly incorporated by reference, in its entirety, into the present application.

### BACKGROUND

### 1. Field

The disclosed subject matter relates to video encoding and/or decoding, and more specifically, to signaling video usage for AI-driven processes in the form of a Supplementary Enhancement Information (SEI) messages.

### 2. Description of Related Art

Video encoding and/or decoding using inter-picture prediction with motion compensation has been known for decades. Uncompressed digital video can consist of a series of pictures, each picture having a spatial dimension of, for example, 1920×1080 luminance samples and associated chrominance samples. The series of pictures can have a fixed or variable picture rate (informally also known as frame rate), of, for example 60 pictures per second or 60 Hz. Uncompressed video has significant bitrate requirements. For example, 1080p60 4:2:0 video at 8 bit per sample (1920×1080 luminance sample resolution at 60 Hz frame rate) requires close to 1.5 Gbit/s bandwidth. An hour of such video requires more than 600 GByte of storage space.

One purpose of video coding and decoding can be the reduction of redundancy in the input video signal, through compression. Compression can help reducing aforementioned bandwidth or storage space requirements, in some cases by two orders of magnitude or more. Both lossless and lossy compression, as well as a combination thereof can be employed. Lossless compression refers to techniques where an exact copy of the original signal can be reconstructed from the compressed original signal. When using lossy compression, the reconstructed signal may not be identical to the original signal, but the distortion between original and reconstructed signal is small enough to make the reconstructed signal useful for the intended application. In the case of video, lossy compression is widely employed. The amount of distortion tolerated depends on the application; for example, users of certain consumer streaming applications may tolerate higher distortion than users of television contribution applications. The compression ratio achievable can reflect that: higher allowable/tolerable distortion can yield higher compression ratios.

A video encoder and decoder can utilize techniques from several broad categories, including, for example, motion compensation, transform, quantization, and entropy coding, some of which will be introduced below.

Generative Artificial Intelligence, (henceforth “generative AI” or “AI” can be used to create or modify images or sequences of images (video). For example, at the time of writing there exist applications and web pages on the world wide web that allow the generation of an image-a map of pixels—from a string that is entered into the application. The image can be downloaded and processed by image compression tools including, for example, an encoder complying with one of H.266's still image profiles. Similar technology is becoming available at the time of writing for sequences of images, which could be input to, for example, an H.266 video encoder. Similarly, image or video manipulation can be possible. For example, so-called deep-fakes are known to exist that take source images or videos and manipulate them in a way that was not intended by the original content creator. A common example is an audio-visual sequence of a politician where the audio stream has been modified such that the politician is making statements he/she would not make in person, and the video is manipulated to synchronize with the modified audio (lip movements, gestures, and similar).

Copyrights are tools for defining legal regulations regarding the use and distribution of content. However, with the advancement of artificial intelligence (AI) technology, new challenges and considerations have emerged in the diversification of content usage. The use of content through AI can become highly varied and complex, making it difficult for traditional copyright or license terms to clearly define and manage all possible use cases. As a result, depending solely on copyrights or licenses for protection may prove insufficient in addressing the complexities of AI-driven content usage.

### SUMMARY

There is included a method and apparatus comprising memory configured to store computer program code and a processor or processors configured to access the computer program code and operate as instructed by the computer program code. The computer program is configured to cause the processor implement performing a conversion between a visual media file and a bitstream of a visual media data according to a format rule, the format rule indicating to determine, at least one Supplementary Enhancement Information (SEI) message, the SEI message comprising a syntax element indicative of whether a picture is allowed be used by an AI engine as an input.

There is also provided a method for video decoding by at least one processor, comprising: receiving a coded video bitstream comprising a picture to be used by an artificial intelligence (AI) engine; and parsing, from the received picture, at least one Supplementary Enhancement Information (SEI) message, the SEI message comprising a syntax element indicative of whether the picture is allowed be used by the AI engine as an input.

There is also provided a method for video encoding by at least one processor, comprising: receiving a video comprising at least one picture; determining, at least one Supplementary Enhancement Information (SEI) message, the SEI message comprising a syntax element indicative of whether the picture is allowed be used by an AI engine as an input; and encoding a video bitstream comprising the picture and the at least on SEI message.

The syntax element may indicate whether the picture is allowed be used by the AI engine as an input for derivative work.

The syntax element may indicate whether the picture is allowed be used by the AI engine as an input for training.

The syntax element may indicate whether the picture is allowed be used by the AI engine as an input for any usage.

The syntax element may indicate whether the picture requires content owner authorization to be used by the AI engine as an input for any usage.

The syntax element may include a syntax of any of ai_usage_restrictions, aur_cancel_flag, aur_persistence_flag, aur_num_restrictions_minus1, aur_restriction [i], aur_context_present_flag [i], and aur_context [i].

The aur_restriction [i] may represent any of four values comprising:
a first value indicating “do not use in any AI application”,
a second value indicating “do not use for AI training”,
a third value indicating “do not use for generative (modification or creation) AI”, and
a fourth value indicating “do not use for AI inference”, and the aur_context [i] may represent any of:
a first bitMask indicating “commercial use”,
a second bitMask indicating “non-commercial use”,
a third bitMask indicating “official government use”, and
a fourth bitMask indicating “research and academic use”.

### BRIEF DESCRIPTION OF THE DRAWINGS

Further features, nature, and various advantages of the disclosed subject matter will be more apparent from the following detailed description and the accompanying drawings in which:

FIG. 1 is a schematic illustration of a simplified block diagram of a communication system in accordance with one or more embodiments;

FIG. 2 is a schematic illustration of a simplified block diagram of a communication system in accordance with one or more embodiments;

FIG. 3 is a schematic illustration of a simplified block diagram of a decoder in accordance with one or more embodiments;

FIG. 4 is a schematic illustration of a simplified block diagram of an encoder in accordance with one or more embodiments;

FIG. 5 is a schematic illustration of NAL unit and SEI headers in accordance with one or more embodiments;

FIG. 6 is a schematic illustration of system in accordance with one or more embodiments; and

FIG. 7 is a schematic illustration of a computer system in accordance with one or more embodiments.

### DETAILED DESCRIPTION

The proposed features discussed below may be used separately or combined in any order. Further, the embodiments may be implemented by processing circuitry (e.g., one or more processors or one or more integrated circuits). In one example, the one or more processors execute a program that is stored in a non-transitory computer-readable medium.

According to embodiments herein, there is provided an SEI message for marking content that has been created and/or modified by a generative AI engine, fulfilling envisioned regulatory requirements. The disclosed subject matter relates to video coding and decoding and, more specifically, to the inclusion of marker in an SEI message to mark the use of a generative Artificial Intelligence to generate the content of a video segment.

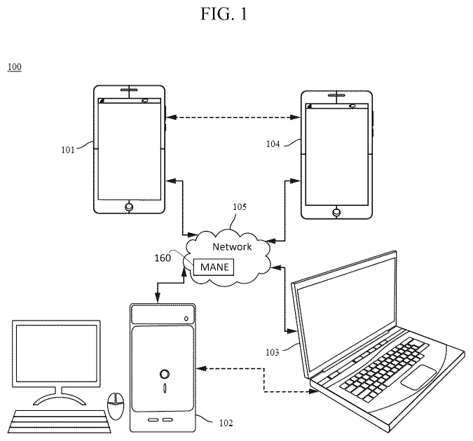

FIG. 1 illustrates a simplified block diagram of a communication system 100 according to an embodiment of the present disclosure. The communication system 100 may include at least two terminals 102 and 103 interconnected via a network 105. For unidirectional transmission of data, a first terminal 103 may code video data at a local location for transmission to the other terminal 102 via the network 105. The second terminal 102 may receive the coded video data of the other terminal from the network 105, decode the coded data and display the recovered video data. Unidirectional data transmission may be common in media serving applications and the like.

FIG. 1 illustrates a second pair of terminals 101 and 104 provided to support bidirectional transmission of coded video that may occur, for example, during videoconferencing. For bidirectional transmission of data, each terminal 101 and 104 may code video data captured at a local location for transmission to the other terminal via the network 105. Each terminal 101 and 104 also may receive the coded video data transmitted by the other terminal, may decode the coded data and may display the recovered video data at a local display device.

In FIG. 1, the terminals 101, 102, 103 and 104 may be illustrated as servers, personal computers and smart phones but the principles of the present disclosure are not so limited. Embodiments of the present disclosure find application with laptop computers, tablet computers, media players and/or dedicated video conferencing equipment. The network 105 represents any number of networks that convey coded video data among the terminals 101, 102, 103 and 104, including for example wireline and/or wireless communication networks. The communication network 105 may exchange data in circuit-switched and/or packet-switched channels. Representative networks include telecommunications networks, local area networks, wide area networks and/or the Internet. For the purposes of the present discussion, the architecture and topology of the network 105 may be immaterial to the operation of the present disclosure unless explained herein below. The network (150) may include Media Aware Network Elements (MANEs, 160) that may be included in the transmission path between, for example, terminal (130) and (140). The purpose of a MANE may be selective forwarding of parts of the media data to react to network congestions, media switching, media mixing, archival, and similar tasks commonly performed by a service provider rather than an end user. Such MANEs may be able to parse and react on a limited part of the media conveyed over the network, for example syntax elements related to the network abstraction layer of video coding technologies or standards.

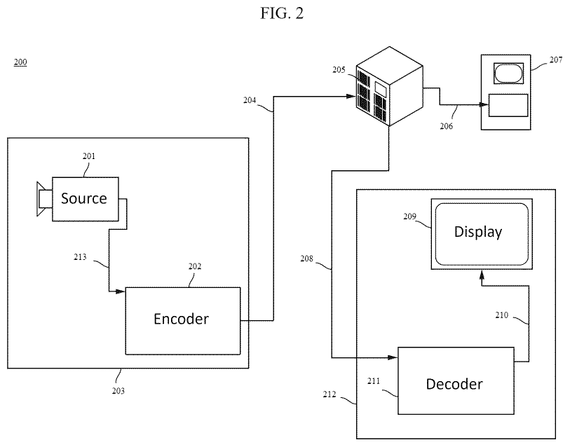

FIG. 2 illustrates, as an example for an application for the disclosed subject matter, the placement of a video encoder and decoder in a streaming environment. The disclosed subject matter can be equally applicable to other video enabled applications, including, for example, video conferencing, digital TV, storing of compressed video on digital media including CD, DVD, memory stick and the like, and so on.

A streaming system may include a capture subsystem 203, that can include a video source 201, for example a digital camera, creating, for example, an uncompressed video sample stream 213. That sample stream 213 may be emphasized as a high data volume when compared to encoded video bitstreams and can be processed by an encoder 202 coupled to the camera 201. The encoder 202 can include hardware, software, or a combination thereof to enable or implement aspects of the disclosed subject matter as described in more detail below. The encoded video bitstream 204, which may be emphasized as a lower data volume when compared to the sample stream, can be stored on a streaming server 205 for future use. One or more streaming clients 212 and 207 can access the streaming server 205 to retrieve copies 208 and 206 of the encoded video bitstream 204. A client 212 can include a video decoder 211 which decodes the incoming copy of the encoded video bitstream 208 and creates an outgoing video sample stream 210 that can be rendered on a display 209 or other rendering device (not depicted). In some streaming systems, the video bitstreams 204, 206 and 208 can be encoded according to certain video coding/compression standards. Examples of those standards are noted above and described further herein. Examples of those standards also include ITU-T Recommendations H.265 and H.266. The disclosed subject matter may be used in the context of VVC for example.

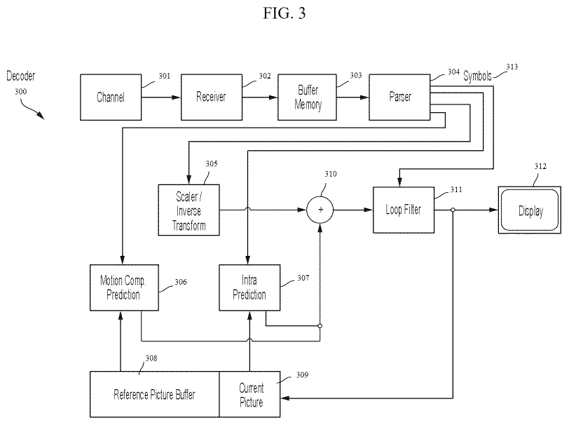

FIG. 3 may be a functional block diagram of a video decoder 300 according to an embodiment of the present invention.

A receiver 302 may receive one or more codec video sequences to be decoded by the decoder 300; in the same or another embodiment, one coded video sequence at a time, where the decoding of each coded video sequence is independent from other coded video sequences. The coded video sequence may be received from a channel 301, which may be a hardware/software link to a storage device which stores the encoded video data. The receiver 302 may receive the encoded video data with other data, for example, coded audio data and/or ancillary data streams, that may be forwarded to their respective using entities (not depicted). The receiver 302 may separate the coded video sequence from the other data. To combat network jitter, a buffer memory 303 may be coupled in between receiver 302 and entropy decoder/parser 304 (“parser” henceforth). When receiver 302 is receiving data from a store/forward device of sufficient bandwidth and controllability, or from an isosychronous network, the buffer 303 may not be needed, or can be small. For use on best effort packet networks such as the Internet, the buffer 303 may be required, can be comparatively large and can advantageously of adaptive size.

The video decoder 300 may include a parser 304 to reconstruct symbols 313 from the entropy coded video sequence. Categories of those symbols include information used to manage operation of the decoder 300, and potentially information to control a rendering device such as a display 312 that is not an integral part of the decoder but can be coupled to it. The control information for the rendering device(s) may be in the form of Supplementary Enhancement Information (SEI messages) or Video Usability Information parameter set fragments (not depicted). The parser 304 may parse/entropy-decode the coded video sequence received. The coding of the coded video sequence can be in accordance with a video coding technology or standard, and can follow principles well known to a person skilled in the art, including variable length coding, Huffman coding, arithmetic coding with or without context sensitivity, and so forth. The parser 304 may extract from the coded video sequence, a set of subgroup parameters for at least one of the subgroups of pixels in the video decoder, based upon at least one parameters corresponding to the group. Subgroups can include Groups of Pictures (GOPs), pictures, tiles, slices, macroblocks, Coding Units (CUs), blocks, Transform Units (TUs), Prediction Units (PUs) and so forth. The entropy decoder/parser may also extract from the coded video sequence information such as transform coefficients, quantizer parameter values, motion vectors, and so forth.

The parser 304 may perform entropy decoding/parsing operation on the video sequence received from the buffer 303, so to create symbols 313. The parser 304 may receive encoded data, and selectively decode particular symbols 313. Further, the parser 304 may determine whether the particular symbols 313 are to be provided to a Motion Compensation Prediction unit 306, a scaler/inverse transform unit 305, an Intra Prediction Unit 307, or a loop filter 311.

Reconstruction of the symbols 313 can involve multiple different units depending on the type of the coded video picture or parts thereof (such as: inter and intra picture, inter and intra block), and other factors. Which units are involved, and how, can be controlled by the subgroup control information that was parsed from the coded video sequence by the parser 304. The flow of such subgroup control information between the parser 304 and the multiple units below is not depicted for clarity.

Beyond the functional blocks already mentioned, decoder 300 can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit 305. The scaler/inverse transform unit 305 receives quantized transform coefficient as well as control information, including which transform to use, block size, quantization factor, quantization scaling matrices, etc. as symbol(s) 313 from the parser 304. It can output blocks comprising sample values, that can be input into aggregator 310.

In some cases, the output samples of the scaler/inverse transform 305 can pertain to an intra coded block; that is: a block that is not using predictive information from previously reconstructed pictures, but can use predictive information from previously reconstructed parts of the current picture. Such predictive information can be provided by an intra picture prediction unit 307. In some cases, the intra picture prediction unit 307 generates a block of the same size and shape of the block under reconstruction, using surrounding already reconstructed information fetched from the current (partly reconstructed) picture 309. The aggregator 310, in some cases, adds, on a per sample basis, the prediction information the intra prediction unit 307 has generated to the output sample information as provided by the scaler/inverse transform unit 305.

In other cases, the output samples of the scaler/inverse transform unit 305 can pertain to an inter coded, and potentially motion compensated block. In such a case, a Motion Compensation Prediction unit 306 can access reference picture memory 308 to fetch samples used for prediction. After motion compensating the fetched samples in accordance with the symbols 313 pertaining to the block, these samples can be added by the aggregator 310 to the output of the scaler/inverse transform unit (in this case called the residual samples or residual signal) so to generate output sample information. The addresses within the reference picture memory form where the motion compensation unit fetches prediction samples can be controlled by motion vectors, available to the motion compensation unit in the form of symbols 313 that can have, for example X, Y, and reference picture components. Motion compensation also can include interpolation of sample values as fetched from the reference picture memory when sub-sample exact motion vectors are in use, motion vector prediction mechanisms, and so forth.

The output samples of the aggregator 310 can be subject to various loop filtering techniques in the loop filter unit 311. Video compression technologies can include in-loop filter technologies that are controlled by parameters included in the coded video bitstream and made available to the loop filter unit 311 as symbols 313 from the parser 304, but can also be responsive to meta-information obtained during the decoding of previous (in decoding order) parts of the coded picture or coded video sequence, as well as responsive to previously reconstructed and loop-filtered sample values.

The output of the loop filter unit 311 can be a sample stream that can be output to the display 312, which may be a render device, as well as stored in the reference picture memory 557 for use in future inter-picture prediction.

Certain coded pictures, once fully reconstructed, can be used as reference pictures for future prediction. Once a coded picture is fully reconstructed and the coded picture has been identified as a reference picture (by, for example, parser 304), the current reference picture 309 can become part of the reference picture buffer 308, and a fresh current picture memory can be reallocated before commencing the reconstruction of the following coded picture.

The video decoder 300 may perform decoding operations according to a predetermined video compression technology that may be documented in a standard, such as ITU-T Rec. H.265 and/or H.266. The coded video sequence may conform to a syntax specified by the video compression technology or standard being used, in the sense that it adheres to the syntax of the video compression technology or standard, as specified in the video compression technology document or standard and specifically in the profiles document therein. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver 302 may receive additional (redundant) data with the encoded video. The additional data may be included as part of the coded video sequence(s). The additional data may be used by the video decoder 300 to properly decode the data and/or to more accurately reconstruct the original video data. Additional data can be in the form of, for example, temporal, spatial, or signal-to-noise ratio (SNR) enhancement layers, redundant slices, redundant pictures, forward error correction codes, and so on.

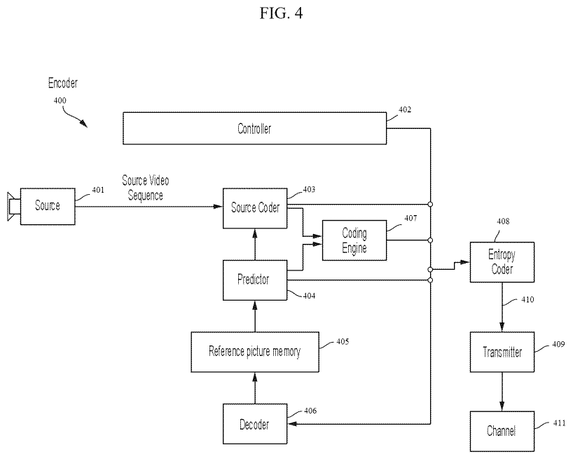

FIG. 4 may be a functional block diagram of a video encoder 400 according to an embodiment of the present disclosure.

The encoder 400 may receive video samples from a video source 401 (that is not part of the encoder) that may capture video image(s) to be coded by the encoder 400.

The video source 401 may provide the source video sequence to be coded by the encoder (303) in the form of a digital video sample stream that can be of any suitable bit depth (for example: 8 bit, 10 bit, 12 bit, . . . ), any colorspace (for example, BT.601 Y CrCB, RGB, . . . ) and any suitable sampling structure (for example Y CrCb 4:2:0, Y CrCb 4:4:4). In a media serving system, the video source 401 may be a storage device storing previously prepared video. In a videoconferencing system, the video source 401 may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. A person skilled in the art can readily understand the relationship between pixels and samples. The description below focuses on samples.

According to an embodiment, the encoder 400 may code and compress the pictures of the source video sequence into a coded video sequence 410 in real time or under any other time constraints as required by the application. Enforcing appropriate coding speed is one function of Controller 402. Controller controls other functional units as described below and is functionally coupled to these units. The coupling is not depicted for clarity. Parameters set by controller can include rate control related parameters (picture skip, quantizer, lambda value of rate-distortion optimization techniques, . . . ), picture size, group of pictures (GOP) layout, maximum motion vector search range, and so forth. A person skilled in the art can readily identify other functions of controller 402 as they may pertain to video encoder 400 optimized for a certain system design.

Some video encoders operate in what a person skilled in the art readily recognizes as a “coding loop.” As an oversimplified description, a coding loop can consist of the encoding part of an encoder (for example a source coder 403) (responsible for creating symbols based on an input picture to be coded, and a reference picture(s)), and a (local) decoder 406 embedded in the encoder 400 that reconstructs the symbols to create the sample data that a (remote) decoder also would create (as any compression between symbols and coded video bitstream is lossless in the video compression technologies considered in the disclosed subject matter). That reconstructed sample stream is input to the reference picture memory 405. As the decoding of a symbol stream leads to bit-exact results independent of decoder location (local or remote), the reference picture buffer content is also bit exact between local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is well known to a person skilled in the art.

The operation of the “local” decoder 406 can be the same as of a “remote” decoder 300, which has already been described in detail above in conjunction with FIG. 3. Briefly referring also to FIG. 4, however, as symbols are available and en/decoding of symbols to a coded video sequence by entropy coder 408 and parser 304 can be lossless, the entropy decoding parts of decoder 300, including channel 301, receiver 302, buffer 303, and parser 304 may not be fully implemented in local decoder 406.

An observation that can be made at this point is that any decoder technology except the parsing/entropy decoding that is present in a decoder also necessarily needs to be present, in substantially identical functional form, in a corresponding encoder. The description of encoder technologies can be abbreviated as they are the inverse of the comprehensively described decoder technologies. Only in certain areas a more detail description is required and provided below.

As part of its operation, the source coder 403 may perform motion compensated predictive coding, which codes an input frame predictively with reference to one or more previously-coded frames from the video sequence that were designated as “reference frames.” In this manner, the coding engine 407 codes differences between pixel blocks of an input frame and pixel blocks of reference frame(s) that may be selected as prediction reference(s) to the input frame.

The local video decoder 406 may decode coded video data of frames that may be designated as reference frames, based on symbols created by the source coder 403. Operations of the coding engine 407 may advantageously be lossy processes. When the coded video data may be decoded at a video decoder (not shown in FIG. 4), the reconstructed video sequence typically may be a replica of the source video sequence with some errors. The local video decoder 406 replicates decoding processes that may be performed by the video decoder on reference frames and may cause reconstructed reference frames to be stored in the reference picture memory 405. which may be for example a cache. In this manner, the encoder 400 may store copies of reconstructed reference frames locally that have common content as the reconstructed reference frames that will be obtained by a far-end video decoder (absent transmission errors).

The predictor 404 may perform prediction searches for the coding engine 407. That is, for a new frame to be coded, the predictor 404 may search the reference picture memory 405 for sample data (as candidate reference pixel blocks) or certain metadata such as reference picture motion vectors, block shapes, and so on, that may serve as an appropriate prediction reference for the new pictures. The predictor 404 may operate on a sample block-by-pixel block basis to find appropriate prediction references. In some cases, as determined by search results obtained by the predictor 404, an input picture may have prediction references drawn from multiple reference pictures stored in the reference picture memory 405.

The controller 402 may manage coding operations of the video coder 403, including, for example, setting of parameters and subgroup parameters used for encoding the video data.

Output of all aforementioned functional units may be subjected to entropy coding in the entropy coder 408. The entropy coder translates the symbols as generated by the various functional units into a coded video sequence, by loss-less compressing the symbols according to technologies known to a person skilled in the art as, for example Huffman coding, variable length coding, arithmetic coding, and so forth.

The transmitter 409 may buffer the coded video sequence(s) as created by the entropy coder 408 to prepare it for transmission via a communication channel 411, which may be a hardware/software link to a storage device which would store the encoded video data. The transmitter 409 may merge coded video data from the video coder 403 with other data to be transmitted, for example, coded audio data and/or ancillary data streams (sources not shown).

The controller 402 may manage operation of the encoder 400. During coding, the controller 405 may assign to each coded picture a certain coded picture type, which may affect the coding techniques that may be applied to the respective picture. For example, pictures often may be assigned as one of the following frame types:

An Intra Picture (I picture) may be one that may be coded and decoded without using any other frame in the sequence as a source of prediction. Some video codecs allow for different types of Intra pictures, including, for example Independent Decoder Refresh Pictures. A person skilled in the art is aware of those variants of I pictures and their respective applications and features.

A Predictive picture (P picture) may be one that may be coded and decoded using intra prediction or inter prediction using at most one motion vector and reference index to predict the sample values of each block.

A Bi-directionally Predictive Picture (B Picture) may be one that may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

The video coder 400 may perform coding operations according to a predetermined video coding technology or standard, such as ITU-T Rec. H.265 and/or H.266. In its operation, the video coder 400 may perform various compression operations, including predictive coding operations that exploit temporal and spatial redundancies in the input video sequence. The coded video data, therefore, may conform to a syntax specified by the video coding technology or standard being used.

In an embodiment, the transmitter 409 may transmit additional data with the encoded video. The source coder 403 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and so on.

Compressed video can be augmented, in the video bitstream, by supplementary enhancement information, for example in the form of Supplementary Enhancement Information (SEI) Messages or Video Usability Information (VUI). Video coding standards can include specifications parts for SEI and VUI. SEI and VUI information may also be specified in stand-alone specifications that may be referenced by the video coding specifications.

According to embodiments herein, the processes both of encoding and of decoding may each be considered to be processing of visual media data performing a conversion between a visual media file and a bitstream of a visual media data according to a format rule.

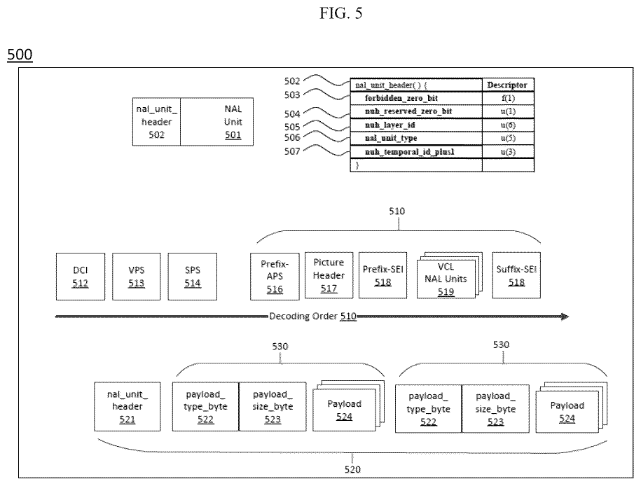

Referring to FIG. 5, shown is an example 500 of an exemplary layout of a Coded Video Sequence (CVS) in accordance with H.266 and embodiments herein. The coded video sequence is subdivided into Network Abstraction Layer units (NAL units). An exemplary NAL unit 501 can include a NAL unit header 502, which in turn comprises 16 bits as follows: a forbidden_zero_bit 503 and nuh_reserved_zero_bit 504 may be unused by H.266 and may be zero in a NAL unit compliant with H.266. Three bits of nuh_layer_id 505 may be indicative of the (spatial, SNR, or multiview enhancement) layer to which the NAL unit belongs. Five bits of nuh_nal_unit_type 506 define the type of NAL unit. In H.266 according to embodiments herein, 22 NAL unit type values are defined for NAL unit types, six NAL unit types are reserved, and four NAL unit type values are unspecified and can be used by specifications other than H.266. Finally, three bits of the NAL unit header 502 indicate the temporal layer to which the NAL unit belongs nuh_temporal_id_plus1 506.

A coded picture may contain one or more Video Coding Layer (VCL) NAL units and zero or more non-VCL NAL units. VCL NAL units may contain coded data conceptually belonging to a video coding layer as introduced before. Non-VCL NAL units may contain data conceptually belonging data not conceptually belonging to the video coding layer. Using H.266 as an example, those units can be categorized into parameter sets, picture header, NAL units, Prefix and Suffix SEI Nal unit types, Filler Data NAL unit type FD_NUT, and Reserved and Unspecified NAL unit types.
(1) Parameter sets, which comprise information that can be necessary for the decoding process and can apply to more than one coded picture. Parameter sets and conceptually similar NAL units may be of NAL unit types such as DCI_NUT (Decoding Capability Information (DCI)), VPS_NUT (Video Parameter Set (VPS), establishing, among other things, layer relationships), SPS_NUT (Sequence Parameter Set (SPS), establishing, among other things, parameters used and staying constant throughout a coded video sequence CVS), PPS_NUT (Picture Parameter Set (PPS), establishing, among other things, parameter used and staying constant within a coded picture), and PREFIX_APS_NUT and SUFFIX_APS_NUT (prefix and suffix Adaptation Parameter Sets). Parameter sets may include information required for a decoder to decode VCL NAL units, and hence are referred here as “normative” NAL units.
(2) Picture Header (PH_NUT), which is also a “normative” NAL unit.
(3) NAL units marking certain places in a NAL unit stream. Those include NAL units with the NAL unit types AUD_NUT (Access Unit Delimiter), EOS_NUT (End of Sequence) and EOB_NUT (End of Bitstream). These are non-normative, also known as informative, in the sense that a compliant decoder does not require them for its decoding process, although it needs to be able to receive them in the NAL unit stream.
(4) Prefix and Suffix SEI Nal unit types (PREFIX_SEI_NUT and SUFFIX_SEI_NUT) which indicate NAL units containing Prefix and Suffix supplementary enhancement information. IN H.266 (04/2022), those NAL units are informative, as they are not required for the decoding process.
(5) Filler Data NAL unit type FD_NUT indicates filler data; data that can be random and can be used to “waste” bits in a NAL unit stream or bitstream, which may be necessary for the transport over certain isochronous transport environments.
(6) Reserved and Unspecified NAL unit types.

Still referring to FIG. 5, shown is a layout of a NAL unit stream in decoding order 510 containing a coded picture 511 containing NAL units of some of the types previously introduced. Somewhere early in the NAL unit stream, DCI 512, VPS 513, and SPS 514 may, in combination, establish the parameters which the decoder can use to decode the coded pictures of a coded video sequence (CVS), including coded picture 511 of the NAL unit stream.

The coded picture 511 can contain, in the depicted order or any other order compliant with the video coding technology or standard in use (here: H.266): a Prefix APS 516, Picture header (PH, 517), prefix SEI 518, one or more VCL NAL units 519, and suffix SEI 520.

Prefix and suffix SEI NAL units 518 and 520 were motivated during the standards development as, for some SEI messages, the content of the message would be known before the coding of a given picture commences, whereas other content would only be known once the picture were coded. Allowing certain SEI messages to appear early or late in a coded picture's NAL unit stream through prefix and suffix SEIs allows avoiding buffering. As one example, in an encoder the sampling time of a picture to be coded is known before the picture is coded, and hence the picture timing SEI message can be a prefix SEI message 516. On the other hand, a decoded picture hash SEI message, which contains a hash of the sample values of a decoded pictures and can be useful, for example, to debug encoder implementations, is a suffix SEI message 518 as an encoder cannot calculate a hash over reconstructed samples before a picture has been coded. The location of Prefix and Suffix SEI NAL units may not be restricted to their position in the NAL unit stream. The phrase “Prefix” and “Suffix” may imply to what coded pictures or NAL units the Prefix/Suffix SEI message may pertain to, and the details of this applicability may be specified, for example in the semantics description of a given SEI message.

Still referring to FIG. 5, shown is a simplified syntax diagram of a NAL unit that contains a prefix or suffix SEI message 520. This syntax can be a container format for multiple SEI messages that can be carried in one NAL unit. Details of the extension mechanism for both payload size and payload type numbering range specified in H.266 are omitted here for clarity. As other NAL units, SEI NAL units start with a NAL unit header 521. The header is followed by one or more SEI messages; two are depicted 530, 531 and described henceforth. Each SEI message inside the SEI NAL unit may include an 8 bit payload_type_byte 522 which specifies one of 256 different SEI types (or extension indication); an 8 bit payload_size_byte 523 which specifies the number of bytes of the SEI payload (or the presence of an extension block), and payload_size-byte number minus 1 bytes of Payload 524. The syntax of the Payload 524 depends on the SEI message, it can be of any length between 0 and 254 bytes unless the extension mechanism is used (not shown), in which case the syntax would allow for unlimited payload sizes.

Generative AI has become a challenging new technology form a societal viewpoint. Modifying, or “doctoring” media such as audio, images, and video, which up until a few years ago required specialized, highly developed talent and skills, and often a significant amount of time and at significant cost, is now available to individuals with access to computers and the Internet for free or at comparatively low cost. Content creation increasingly relies on AI-based tools.

Today, many view the use of AI to create new, original content as just another tool, akin a brush or a violin. However, there is a certain amount of content created using AI for arguably malicious reasons-faking speeches of politicians or other media stars, creating fake documentary that, today, the general public takes for granted as being original capture, and so forth. Copyrights are tools for defining legal regulations regarding the use and distribution of content. However, with the advancement of artificial intelligence (AI) technology, new challenges and considerations have emerged in the diversification of content usage. The use of content through AI can become highly varied and complex, making it difficult for traditional copyright or license terms to clearly define and manage all possible use cases. As a result, depending solely on copyrights or licenses for protection may prove insufficient in addressing the complexities of AI-driven content usage.

There are aspects of AI-driven content usage that may not be clearly covered by the current state-of-art copyrights or license terms in most jurisdictions. Specifically, the current regulations are unable to handle high volume and variety of data, lack clarity in fair use guidelines, and cannot adapt to rapid technological advancements.

First, the current law and regulations are unable to handle high volume and variety of data AI requires vast amounts of data for effective training. The sheer volume and variety of video content used can make it difficult to track the AI usage permission status of each piece of content, leading to unintentional infringements.

Second, the current law and regulations lack clarity in fair use guidelines. The concept of fair use is often subject to legal interpretations, and guidelines for such interpretations can vary by jurisdictions. Users may find it challenging to determine whether their use of copyrighted video content for training AI models falls within the scope of fair use, especially when the content is transformed or used in ways not originally intended by the copyright holder.

Third, the current law and regulations cannot adopt to rapid technological advancements. The fast pace of technological advancements in AI often outstrips the development of corresponding legal frameworks. This can leave users in a gray area, uncertain about the legal implications of using certain video content for AI training purposes. This uncertainty is compounded by the fact that current copyright frameworks often lack AI usage restrictions, adding complexity to the legal landscape for AI applications in video content.

In situations where guidelines and legal regulations regarding AI's use of video media contents are unclear or not yet established, copyright holders, such as filmmakers, studios, and digital content creators, should develop and announce specific restrictions and recommendations concerning AI's video usage. By doing so, these content owners may set indication of how their content should be utilized by AI, providing unequivocal guidance to AI developers and users alike. Such initiatives not only foster ethical and legally compliant behavior in AI's video usage but also enhance collaboration between content owners and AI developers, preventing unnecessary disputes.

Embodiments of the present application provide mechanisms for signaling AI usage and/or constraints information regarding video media contents. Such AI usage and/or constraints information can be in the form of strings that express guidelines, permissions, constraints of how a reconstructed picture or video may be permitted to be used in AI-driven processes. The following lists are some examples of the AI usage and/or constraints information regarding video media contents that can be signaled in accordance with the present application.
“This image or video data is permitted to be used as an input for any AI processes.”
“This image or video data requires owner authorization in order to be used as an input for any AI processes.”
“This image or video data cannot be used as an input for any AI processes.”
“This image or video data is permitted to be used as an input for any AI training.”
“This image or video data requires owner authorization in order to be used as an input for any AI training.”
“This image or video data cannot be used as an input for any AI training.”
“This image or video data is permitted to be used as an input for generative AI training.”
“This image or video data requires owner authorization in order to be used as an input for generative AI training.”
“This image or video data cannot be used as an input for generative AI training.”

“This image or video data is permitted to be used as an input for creating deviations by generative AI processes.”
“This image or video data requires owner authorization in order to be used as an input for creating deviations by generative AI processes.”
“This image or video data cannot be used as an input for creating deviations by generative AI processes.”
“The use of personal information contained in this image or video data is prohibited.”
“The use of personal information contained in this image or video data requires owner authorization.”

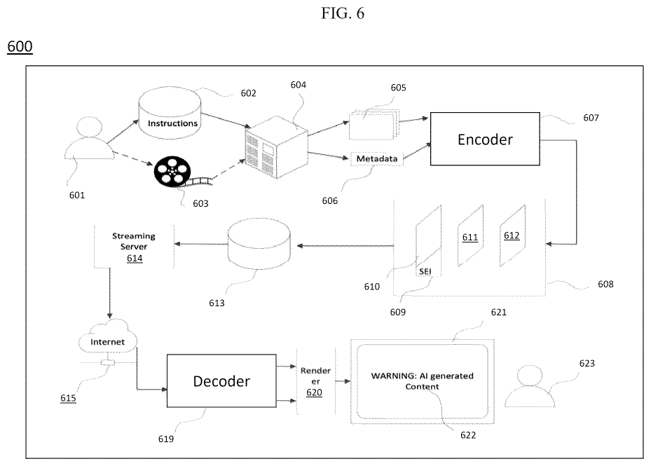

See the display 621 in the example 600 of FIG. 6 illustrating such output display message 622 as a warning or the like to user 623 according to example embodiments.

The above list is by example only. The examples are non-exhaustive and non-limiting. A common theme behind these examples is to provide machine-readable information that give explicit guidance to an AI regarding whether and to what extent the AI can use an image or video as an input to generate AI-driven output in a video bitstream for its purposes.

The SEI messages can indicate such AI usage and/or constraints information at a picture level or a sequence level. The SEI messages may be signaled in several ways, such as, within a copyright SEI message, in a pre-defined SEI message.

In some embodiments, the usage and/or constraints information for AI-driven processes is defined and signaled within a copyright SEI. The copyright SEI defines an ci_ai_usage_information_present_flag to indicate whether usage and/or constraints information for AI-driven processes are present. ci_ai_usage_information_present_flag equals to 1 specifies that usage and/or constraints information for AI-driven processes is present. ci_ai_usage_information_present_flag equals to 0 specifies that usage and/or constraints information for AI-driven processes is absent. When usage and/or constraints information for AI-driven processes is present, a second syntax element ci_ai_usage_information can be further signaled to define specific usage and/or constraints information for AI-driven processes or recommendations related to AI.

Table 1 below shows an example syntax for copyright SEI messages.

TABLE 1
Example Syntax for Copyright SEI Messages

| copyright_information( payloadSize ) { | Descriptor |
|---|---|
| ci_cancel_flag | u(1) |
| if( !ci_cancel_flag ) { | |
| ci_persistence_flag | u(1) |
| ci_information | u(v) |
| cia_ai_usage_information_present_flag | u(1) |
| if( ci_ai_usage_information_present_flag) | |
| ci_ai_usage_information | u(v) |

}
}

The following definitions are example semantics for the new flags in the copyright SEI messages:

ci_ai_usage_information_present_flag equal to 1 specifies that the flag aiua_ai_usage_information is present. aiua_ai_usage_informatioin_present_flag equal to 0 specifies that the flag aiua_ai_usage_information is not present. ci_ai_usage_information specifies usage and constraints information for AI-driven processes or recommendations related to AI for pictures within the persistence scope defined by aiua_cancel_flag and aiua_persistence_flag.

In some embodiments, the usage and/or constraints information for AI-driven processes is defined and signaled in a pre-defined SEI message. The pre-defined SEI message defines an aiua_ai_cancel_flag to indicate whether the SEI message cancels persistence of any previous image or video content usage and constraints information. Also, the pre-defined SEI defines an aiua_persistence_flag to indicate the persistence of the image or video content usage and constraints. Further, the pre-defined SEI defines an aiua_ai_information to indicate constraints and recommendations related to AI processes using pictures within the persistence scope defined by aiua_cancel_flag and aiua_persistence_flag.

Table 2 below shows an example syntax for pre-defined SEI messages.

TABLE 2
Example Syntax for Pre-Defined SEI Messages

| ai_usage_allowed_information ( payloadSize ) { | Descriptor |
|---|---|
| aiua_cancel_flag | u(1) |
| if( !aiua_cancel_flag ) { | |
| aiua_persistence_flag | u(1) |
| aiua_information | u(v) |
| } | |
| } | |

The following definitions are example semantics for the new flags in the pre-defined SEI messages.

aiua_cancel_flag indicates whether the SEI message cancels the persistence of any previous image or video content usage and constraints information in output order that applies to the current layer. aiua_cancel_flag equal to 1 specifies that the SEI message cancels the persistence of any previous image or video content usage and constraints information in output order that applies to the current layer. aiua_cancel_flag equal to 0 specifies that image or video content usage and constraints information follows.

aiua_persistence_flag indicates the persistence of previous image or video content usage and constraints information for the current layer. cui_persistence_flag equal to 1 specifies that previous image or video content usage and constraints information applies to the current decoded picture and persists for all subsequent pictures of the current layer in output order until one or more of the following conditions are true:
A new CLVS of the current layer begins.
The bitstream ends.
A picture in the current layer in an AU associated with a content usage information SEI message is output that follows the current picture in output order. aiua_persistence_flag equal to 0 specifies that the persistence of previous image or video content usage and constraints information applies to the current decoded picture only. aiua_ai_information constraints and recommendations related to AI processes using pictures within the persistence scope defined by aiua_cancel_flag and aiua_persistence_flag.

In some embodiments, the usage and/or constraints information for AI-driven processes can be defined and signaled in a pre-defined SEI message. For example, the pre-defined SEI message defines an aiua_deviation_not_allowed_flag to indicate whether pictures within the persistence scope defined by aiua_cancel_flag and aiua_persistence_flag are allowed to be used by AI to create a derivative. aiua_deviation_not_allowed_flag equal to 1 specifies a generative AI engine aware of the SEI message that it is not allowed to use the picture for creating a derivative. aiua_deviation_not_allowed_flag equal to 0 specifies that it is undefined whether the generative AI engine is allowed to use the picture for derivative work. Note that it cannot be inferred that a picture marked with aiua_deviation_not_allowed_flag equal to 0 is allowed be used by the generative AI engine for derivative work because circumstances not known by the encoder may legally prevent the picture from being allowed for generative AI processing. When aiua_deviation_not_allowed_flag equal to 0, the image or video data may require explicit owner authorization to be used as an input for creating deviations by generative AI processes.

In some embodiments, the usage and/or constraints information for AI-driven processes can be defined and signaled in a pre-defined SEI message. For example, the pre-defined SEI message defines an aiua_training_not_allowed_flag to indicate pictures within the persistence scope defined by aiua_cancel_flag and aiua_persistence_flag are allowed to be used by AI for training. aiua_training_not_allowed_flag equal to 1 instructs an AI engine aware of the SEI message that it is not allowed to use the picture for training.

aiua_training_not_allowed_flag equal to 0 specifies that it is undefined whether the AI engine is allowed to use the picture for training. Note that, it cannot be inferred that a picture marked with aiua_training_not_allowed equal to 0 can be used by an AI for training because circumstances not known by the encoder may legally prevent the picture from being allowed for training. When aiua_training_not_allowed_flag equal to 0, the image or video data may require explicit owner authorization to be used as an input for creating deviations by generative AI processes.

In some embodiments, the usage and/or constraints information for AI-driven processes can be defined and signaled in a pre-defined SEI message. For example, the pre-defined SEI message defines an aiua_input_not_allowed_flag to indicate whether pictures within the persistence scope defined by aiua_cancel_flag and aiua_persistence_flag can be used as input to any AI processes regardless of purposes, such as derivative work, training, and so on. aiua_input_not_allowed_flag equal to 1 instructs an AI engine aware of the SEI message that it is not allowed to use the picture as an input for any purposes. aiua_input_not_allowed_flag equal to 0 specifies that it is undefined whether the AI engine is allowed to use the picture for any purposes. Note that, it cannot be inferred that a picture marked with aiua_input_not_allowed equal to 0 can be used by the AI engine because circumstances not known by the encoder may legally prevent the picture from being allowed for training. When aiua_input_not_allowed_flag equal to 0, the image or video data may require explicit owner authorization to be used as an input for creating deviations by generative AI processes.

In some embodiments, the usage and/or constraints information for AI-driven processes can be defined and signaled in a pre-defined SEI message. For example, the pre-defined SEI message defines an aiua_owner_auth_required_flag to indicate whether pictures within the persistence scope defined by aiua_cancel_flag and aiua_persistence_flag require explicit owner authorization to be used as input to any AI processes.

aiua_owner_auth_required_flag equal to 1 instructs an AI engine aware of the SEI message that it is required to obtain explicit content owner authorization to use the picture for any purposes.

aina_training_not_allowed_flag equal to 0 specifies that it is undefined whether the AI engine is required to obtain explicit content owner authorization to use the picture for any purposes.

Table 3 below shows another example syntax for pre-defined SEI messages.

TABLE 3
Example Syntax for Pre-Defined SEI Messages

| ai_usage_allowed_information( payloadSize ) { | Descriptor |
|---|---|
| aiua_cancel_flag | u(1) |
| if( !aiua_cancel_flag ) { | |
| aiua_persistence_flag | u(1) |
| aiua_training_not_allowed_flag | u(1) |
| aiua_derivation_not_allowed_flag | u(1) |
| ... ... | |
| } | |
| } | |

Table 4 below shows yet another example syntax for pre-defined SEI messages.

TABLE 4
Example Syntax for Pre-Defined SEI Messages

| ai_usage_allowed_information( payloadSize ) { | Descriptor |
|---|---|
| aiua_cancel_flag | u(1) |
| if( !aiua_cancel_flag ) { | |
| aiua_persistence_flag | u(1) |
| aiua_input_not_allowed_flag | u(1) |
| If( !aiua_input_not_allowed_flag ) { | |
| aiua_training_not_allowed_flag | u(1) |
| aiua_derivation_not_allowed_flag | u(1) |
| } | |
| aiua_owner_auth_required_flag | u(1) |
| ... ... | |
| } | |
| } | |

The advantage of having the 1-bit flags in the pre-defined SEI messages as shown in Table 3 and Table 4 is that a machine can more easily parse well-defined bits than free-text information. In other words, guidance according to syntax defined in Table 3 and/or Table 4 can be processed by a machine without needing additional human interpretations, whereas syntax defined in Table 2 provides more flexibility and details for the usage and constraints information.

The disclosed subject matter relates to signaling video usage for AI-driven processed in the form of Supplementary Enhancement Information (SEI) messages. SEI messages have been used for the insertion of metadata into compressed video streams since at least 1997. As already described, one or more SEI messages can be carried in a NAL unit. Insofar, the concept of an SEI message can also apply to other NAL-unit based coding technologies, even if in their specifications the term “SEI message” may not exist, Further, the disclosed subject matter may also be applicable beyond NAL-unit based codecs as long as the bitstream format of the codec or bitstream formatter in question allows the insertion of a bitstream into the coded media bits whose format can be associated with metadata. Such codecs or bitstream formatters may include audio, or system-layer multiplexing standards. For clarity, the description below assumes the aforementioned SEI message syntax or a syntax closely related to it, but a person skilled in the art will be able to adapt or modify the inventive subject matter to application needs beyond SEI messages. Also, the description below focusses on a video stream that consists of one or more pictures coded in a format that supports an H.266-like SEI message.

Regulatory activity is underway in several jurisdictions to mandate the use of AI marking. Other possible information that a regulator may consider is an identification of the content used before modifications (if any), and the instructions the AI has received to create/modify the content. Further, regulators in different countries may set not only different, but contradicting requirements, for example when it comes to the presence of information pertaining to individuals, and different priorities with respect to privacy rights versus marking requirements. For example, conceivably, a certain regulator may require the presence of an identification (like social security number) of the person who instructed the AI to generate image or video contents, whereas another regulator may not mandate such information as it values personal privacy higher than including such information in an AI usage SEI.

FIG. 6 depicts a scenario that involves generative AI according to example embodiments. A producer user 601 may have created instructions 602 for the generative AI engine 604. Those instructions may be as simple as a few words of free-form text (for example “create a 10 second video showing a panda riding a bicycle through a city”), or more complex. For example, the instructions may be a video stream itself providing instructions in the form of sign language. In an AI-creative context, as introduced above, these instructions may be the only user-supplied information the AI responds to. In an AI-modifying context, the AI may also receive a user-specified content 603 to modify, here shown as a film reel. Mixing forms of these two technologies may also be possible; for example, the content 603 to modify may include metadata that contains instructions to the AI engine 604 on how to modify the content.

Details about the mechanism which is used to supply the AI engine 604 with user-provided instructions 602 and, in the modifying content only, the content 603 to be modified, or omitted here. In some cases, the AI engine may be physically located in a datacenter operated by a third-party provider, in which case it is likely supplied with instructions 602 and content 603 over the Internet using, for example, an interactive web page. However, other forms of transmission of instructions 602 and content 603 from the user 601 to the AI engine 604 are also envisioned and provided according to embodiments herein.

The AI engine 604 may take the instructions 602 and, in the modifying use case, the content 603, to create outgoing possibly uncompressed media, in this example an uncompressed series of images (and timing information) that together form an uncompressed video stream 605. The AI engine may also generate certain metadata 606 including, for example, data. The AI engine may further determine whether it is allowed to use the image as an input for the purpose of derivative work, or model training, or both, or any other purposes.

Both uncompressed video stream 605 and metadata 606 may be input to a video encoder 607. The video encoder 607 may compress the uncompressed video stream 605 into a compressed video stream 608 that may include SEI messages 609 associated with certain encoded pictures in the coded video bitstream 608. Shown in the example here are three coded pictures 610, 611, 612, with only the first coded picture 610 has an associated SEI message 609.

The coded video bitstream 608 may be distributed to consuming users, that may include the producing user 601, in ways known to a person skilled in the art. Depicted here is that the coded video stream 609 is stored in a file 613, and then streamed by a streaming server 614 and over a network 615 to a consuming user's endpoint. The endpoint may include a video decoder 619 which reconstructs the streamed coded video stream 609 into a series of decoded pictures 620. The decoder 619 may also extract, from the SEI messages 609 included in the coded video stream 608, AI usage and constraints information along with other metadata. Therefore, the AI usage and constraints information is now available downstream AI engines according to exemplary embodiments.

The AI usage and constraints information may be used as prescribed in the regulatory environment where the decoder and display resides, which may be different form the regulatory environment that rules what the AI needs to include.

According to amendments, an AI usage restrictions SEI message syntax may also be according to the following Table 5:

TABLE 5
AI usage restrictions SEI message syntax

| ai_usage_restrictions ( payloadSize ) { | Descriptor |
|---|---|
| aur_cancel_flag | u(1) |
| if( !aur_cancel_flag ) { | |
| aur_persistence_flag | u(1) |
| aur_num_restrictions_minus1 | ue(v) |
| for( i = 0; i <= aur_num_restrictions_minus1; i++ ) { | |
| aur_restriction[ i ] | ue(v) |
| aur_context_present_flag[ i ] | u(1) |
| if( aur_context_present_flag[ i ] ) | |
| aur_context[ i ] | ue(v) |
| } | |
| } | |
| } | |

The artificial intelligence (AI) usage restrictions SEI message, such as of Table 5 and other messages noted above, signals restriction and optional context information for usage by AI applications according to exemplary embodiments.

The AI usage restrictions SEI message type can be included in a SEI processing order (SPO) SEI message to indicate that the signaled usage restrictions apply to an output of the post-processing indicated by the SPO SEI message. Furthermore, an AI usage restrictions SEI message can be included in a processing order nesting (PON) SEI message, when the signaled usage restrictions apply to post-processed video and do not apply to cropped decoded pictures. Moreover, it is possible to indicate a first set of usage restrictions applying to cropped decoded pictures using a non-nested AI usage restrictions SEI message and a second set of usage restrictions applying to post-processed video using an AI usage restrictions SEI message included in a PON SEI message. The second set can include additional usage restrictions relative to those in the first set according to exemplary embodiments.

When an SPO SEI message is present, the processing chain defined by the SPO SEI message does not include the AI usage restrictions SEI message type, and an AI usage restrictions SEI message that is not included in a PON SEI message is present, the indicated AI usage restrictions apply to both the cropped decoded pictures and the output of the processing chain.

When an SPO SEI message is present and an AI usage restrictions SEI message that is not included in a PON SEI message is present, the SEI messages associated with the processing chain defined by the SPO SEI message shall not contradict with the indicated AI usage restrictions.

For example, both aur_restriction [i] equal to 2 (“do not use for generative AI”) and a generative neural network as an NNPF in a processing chain cannot be indicated.
aur_cancel_flag equal to 1 specifies that the SEI message cancels the persistence of any previous AI usage restrictions SEI message in output order. aur_cancel_flag equal to 0 specifies that AI usage restriction information follows.
aur_persistence_flag specifies the persistence of the AI usage restrictions SEI message for the current layer.
aur_persistence_flag equal to 0 specifies that the AI usage restrictions SEI message applies to the current decoded picture only.
aur_persistence_flag equal to 1 specifies that the AI usage restrictions SEI message applies to the current decoded picture and persists for all subsequent pictures of the current layer in output order until one or more of the following conditions are true:
A new CLVS of the current layer begins.
The bitstream ends.
A picture in the current layer in an AU associated with an AI usage restrictions SEI message is output that follows the current picture in output order.
aur_num_restrictions_minus1 plus one specifies the number of restriction entries that follow.
aur_restriction [i] specifies the i-th restriction as specified in Table 6. The value of aur_restriction [i] shall be in the range of 0 to 3, inclusive. Values greater than 3 for aur_restriction [i] are reserved for future use by ITU-T | ISO/IEC and shall be ignored in bitstreams conforming to this version of that Specification according to embodiments hereiin.

TABLE 6
Definition of aur_restriction[i]

| Value | Interpretation |
|---|---|
| 0 | Do not use in any AI application |
| 1 | Do not use for AI training |
| 2 | Do not use for generative (modification or creation) AI |
| 3 | Do not use for AI inference |

aur_context_present_flag [i] equal to 1 specifies that the context information for aur_restriction [i] is present. aur_context_present_flag [i] equal to 0 specifies that no context information is present for aur_restriction [i]. When aur_context_present_flag [i] is equal to 0, aur_restriction [i] applies regardless of the context.
aur_context [i], when present, indicates the context for the i-th aur_restriction [i] as specified in Table 7, where (aur_context [i] & bitMask) not equal to zero indicates that the i-th restriction applies to the context associated with the bitMask value in Table xy. When aur_context [i] is greater than 0 and (aur_context [i] & bitMask) is equal to zero, the application of the i-th restriction is undefined in the context associated with the bitMask value in Table xy. The value of aur_context [i] shall be in the range of 1 to 15, inclusive, in bitstreams conforming to this version of this Specification. Values greater than 15 are reserved for future use by ITU-T | ISO/IEC and shall be ignored in bitstreams conforming to this version of that Specification according to embodiments herein. When the value of aur_context [i] is greater than 15, decoders conforming to this version of this Specification shall ignore aur_context [i]. aur_context [i] shall not be equal to 0.

TABLE 7
Definition of aur_contex [i]

| bitMask | Interpretation |
|---|---|
| 0x0001 | commercial use |
| 0x0002 | non-commercial use |
| 0x0004 | official government use |
| 0x0008 | research and academic use |

The following Table 8 illustrates a persistence scope of SEI messages (informative) including an SEI message AI usage restrictions according to embodiments herein.

TABLE 8
Persistence scope of SEI messages (informative)

| SEI message | Persistence scope |
|---|---|
| Filler payload | The PU containing the SEI message |
| User data registered by Rec. ITU-T T.35 | Unspecified |
| User data unregistered | Unspecified |
| Film grain characteristics | Specified by the syntax of the SEI message |
| Frame packing arrangement | Specified by the syntax of the SEI message |
| Parameter sets inclusion indication | The CLVS containing the SEI message |
| Decoded picture hash | The PU containing the SEI message |
| Mastering display colour volume | The CLVS containing the SEI message |
| Content light level information | The CLVS containing the SEI message |
| DRAP indication | The picture associated with the SEI message |
| Alternative transfer characteristics | The CLVS containing the SEI message |
| Ambient viewing environment | The CLVS containing the SEI message |
| Content colour volume | Specified by the syntax of the SEI message |
| Equirectangular projection | Specified by the syntax of the SEI message |
| Generalized cubemap projection | Specified by the syntax of the SEI message |
| Sphere rotation | Specified by the syntax of the SEI message |
| Region-wise packing | Specified by the syntax of the SEI message |
| Omnidirectional viewport | Specified by the syntax of the SEI message |
| Frame-field information | The PU containing the SEI message |
| Sample aspect ratio information | Specified by the syntax of the SEI message |
| Annotated regions | Specified by the syntax of the SEI message |
| Scalability dimension information | The CVS containing the SEI message |
| Multiview acquisition information | The CVS containing the SEI message |
| Multiview view position | The CVS containing the SEI message |
| Depth representation information | Specified by the semantics of the SEI message |
| Alpha channel information | Specified by the syntax of the SEI message |
| Extended DRAP indication | The picture associated with the SEI message |
| Display orientation | Specified by the syntax of the SEI message |
| Colour transform information | Specified by the syntax of the SEI message |
| Shutter interval information | The CLVS containing the SEI message |
| Neural-network post-filter characteristics | The CLVS containing the SEI message |
| Neural-network post-filter activation | Specified by the syntax of the SEI message |
| Phase indication | Specified by the semantics of the SEI message |
| SEI processing order | For each value of po_id, the number of SEI |
| | messages and the payloadType codes of the SEI |
| | messages indicated within the SEI processing |
| | order SEI message persist for the CLVS |
| | containing the SEI processing order SEI message. |
| Processing order nesting | Depending on the processing-order-nested SEI |
| | messages. Each processing-order-nested SEI |
| | message has the same persistence scope as if the |
| | SEI message was not nested. |
| Encoder optimization information | Specified by the syntax of the SEI message |
| Source picture timing information | Specified by the syntax of the SEI message |
| Object mask information | Specified by the syntax of the SEI message |
| Modality information | Specified by the syntax of the SEI message |
| Text description information | Specified by the syntax of the SEI message |
| Generative face video | Specified by the semantics of the SEI message |
| Generative face video enhancement | Specified by the semantics of the SEI message |
| Digitally signed content initialization | Specified by the semantics of the SEI message |
| Digitally signed content selection | The PU containing the SEI message |
| Digitally signed content verification | Specified by the semantics of the SEI message |
| AI usage restrictions | Specified by the syntax of the SEI message |
| Packed regions information | Specified by the syntax of the SEI message |
| Image format metadata | Specified by the syntax of the SEI message |

When multiple NNPFs specified by NNPFC SEI messages with different nnpfc_purpose values are activated for the same picture, it is possible that the corresponding NNPF processes have some conflict. Similarly, when an SEI message implying a non-NNPF post-processing process is associated with a picture and an NNPF specified by an NNPFC SEI message with a related purpose is activated for the same picture, it is possible that the corresponding processes have some conflict. Particular care is expected to be exercised in the design of encoders that generate such multiple SEI messages. For example, process-implying SEI messages that have some conflict can be included in different processing chains defined by SEI processing order SEI messages. Alternatively, multiple process-implying SEI messages with related post-processing operations can be used in contexts in which conflicts of usage are unimportant, or not possible, or are managed—e.g., defined or managed in the controlling application or transport specification, or by controlling the environment in which bitstreams are distributed.

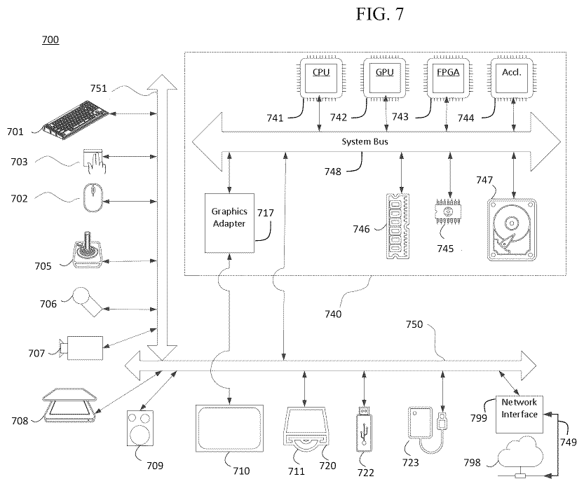

The techniques for signaling video usage for AI-driven processes in SEI messages, described above, can be implemented as computer software using computer-readable instructions and physically stored in one or more computer-readable media. For example, FIG. 7 shows a computer system 700 suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 7 for computer system 700 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system 700.

Computer system 700 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 701, mouse 702, trackpad 703, touch screen 710, joystick 705, microphone 706, scanner 708, camera 707.

Computer system 700 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 710, or joystick 705, but there can also be tactile feedback devices that do not serve as input devices), audio output devices (such as: speakers 709, headphones (not depicted)), visual output devices (such as screens 710 to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system 700 can also include human accessible storage devices and their associated media such as optical media including CD/DVD ROM/RW 720 with CD/DVD 711 or the like media, thumb-drive 722, removable hard drive or solid state drive 723, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 700 can also include interface 799 to one or more communication networks 798. Networks 798 can for example be wireless, wireline, optical. Networks 798 can further be local, wide-area, metropolitan, vehicular and industrial, real-time, delay-tolerant, and so on. Examples of networks 798 include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks 798 commonly require external network interface adapters that attached to certain general-purpose data ports or peripheral buses (750 and 751) (such as, for example USB ports of the computer system 700; others are commonly integrated into the core of the computer system 700 by attachment to a system bus as described below (for example Ethernet interface into a PC computer system or cellular network interface into a smartphone computer system). Using any of these networks 798, computer system 700 can communicate with other entities. Such communication can be uni-directional, receive only (for example, broadcast TV), uni-directional send-only (for example CANbusto certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core 740 of the computer system 700.

The core 740 can include one or more Central Processing Units (CPU) 741, Graphics Processing Units (GPU) 742, a graphics adapter 717, specialized programmable processing units in the form of Field Programmable Gate Areas (FPGA) 743, hardware accelerators for certain tasks 744, and so forth. These devices, along with Read-only memory (ROM) 745, Random-access memory 746, internal mass storage such as internal non-user accessible hard drives, SSDs, and the like 747, may be connected through a system bus 748. In some computer systems, the system bus 748 can be accessible in the form of one or more physical plugs to enable extensions by additional CPUs, GPU, and the like. The peripheral devices can be attached either directly to the core's system bus 748, or through a peripheral bus 751. Architectures for a peripheral bus include PCI, USB, and the like.

CPUs 741, GPUs 742, FPGAs 743, and accelerators 744 can execute certain instructions that, in combination, can make up the aforementioned computer code. That computer code can be stored in ROM 745 or RAM 746. Transitional data can be also be stored in RAM 746, whereas permanent data can be stored for example, in the internal mass storage 747. Fast storage and retrieval to any of the memory devices can be enabled through the use of cache memory, that can be closely associated with one or more CPU 741, GPU 742, mass storage 747, ROM 745, RAM 746, and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, an architecture corresponding to computer system 700, and specifically the core 740 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 740 that are of non-transitory nature, such as core-internal mass storage 747 or ROM 745. The software implementing various embodiments of the present disclosure can be stored in such devices and executed by core 740. A computer-readable medium can include one or more memory devices or chips, according to particular needs. The software can cause the core 740 and specifically the processors therein (including CPU, GPU, FPGA, and the like) to execute particular processes or particular parts of particular processes described herein, including defining data structures stored in RAM 746 and modifying such data structures according to the processes defined by the software. In addition or as an alternative, the computer system can provide functionality as a result of logic hardwired or otherwise embodied in a circuit (for example: accelerator 744), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for video decoding by at least one processor, comprising:
receiving a coded video bitstream comprising a picture to be used by an artificial intelligence (AI) engine; and
parsing, from the received picture, at least one Supplementary Enhancement Information (SEI) message, the SEI message comprising a syntax element indicative of whether the picture is allowed be used by the AI engine as an input.

2. The method of claim 1, wherein the syntax element indicates whether the picture is allowed be used by the AI engine as an input for derivative work.

3. The method of claim 1, wherein the syntax element indicates whether the picture is allowed be used by the AI engine as an input for training.

4. The method of claim 1, wherein the syntax element indicates whether the picture is allowed be used by the AI engine as an input for any usage.

5. The method of claim 1, wherein the syntax element indicates whether the picture requires content owner authorization to be used by the AI engine as an input for any usage.

6. The method of claim 1, wherein the syntax element comprises a syntax of any of ai_usage_restrictions, aur_cancel_flag, aur_persistence_flag, aur_num_restrictions_minus1, aur_restriction [i], aur_context_present_flag [i], and aur_context [i].

7. The method of claim 1,
wherein aur_restriction [i] represents any of four values comprising:
a first value indicating “do not use in any AI application”,
a second value indicating “do not use for AI training”,
a third value indicating “do not use for generative (modification or creation) AI”, and
a fourth value indicating “do not use for AI inference”, and
wherein aur_context [i] represents any of:
a first bitMask indicating “commercial use”,
a second bitMask indicating “non-commercial use”,
a third bitMask indicating “official government use”, and
a fourth bitMask indicating “research and academic use”.

8. A method for video encoding by at least one processor, comprising:
receiving a video comprising at least one picture;
determining, at least one Supplementary Enhancement Information (SEI) message, the SEI message comprising a syntax element indicative of whether the picture is allowed be used by an AI engine as an input; and
encoding a video bitstream comprising the picture and the at least on SEI message.

9. The method of claim 8, wherein the syntax element indicates whether the picture is allowed be used by the AI engine as an input for derivative work.

10. The method of claim 8, wherein the syntax element indicates whether the picture is allowed be used by the AI engine as an input for training.

11. The method of claim 8, wherein the syntax element indicates whether the picture is allowed be used by the AI engine as an input for any usage.

12. The method of claim 8, wherein the syntax element indicates whether the picture requires content owner authorization to be used by the AI engine as an input for any usage.

13. The method of claim 8, wherein the syntax element comprises a syntax of any of ai_usage_restrictions, aur_cancel_flag, aur_persistence_flag, aur_num_restrictions_minus1, aur_restriction [i], aur_context_present_flag [i], and aur_context [i].

14. The method of claim 13,
wherein aur_restriction [i] represents any of four values comprising:
a first value indicating “do not use in any AI application”,
a second value indicating “do not use for AI training”,
a third value indicating “do not use for generative (modification or creation) AI”, and
a fourth value indicating “do not use for AI inference”, and
wherein aur_context [i] represents any of:
a first bitMask indicating “commercial use”,
a second bitMask indicating “non-commercial use”,
a third bitMask indicating “official government use”, and
a fourth bitMask indicating “research and academic use”.

15. A method of processing visual media data, the method comprising:
obtaining at least one of a visual media file and a bitstream of a visual media data; and
performing a conversion between a visual media file and a bitstream of a visual media data according to a format rule, the format rule indicating to determine, at least one Supplementary Enhancement Information (SEI) message, the SEI message comprising a syntax element indicative of whether a picture is allowed be used by an AI engine as an input.

16. The method of claim 15, wherein the syntax element indicates whether the picture is allowed be used by the AI engine as an input for derivative work.

17. The method of claim 15, wherein the syntax element indicates whether the picture is allowed be used by the AI engine as an input for training.

18. The method of claim 15, wherein the syntax element indicates whether the picture is allowed be used by the AI engine as an input for any usage.

19. The method of claim 15, wherein the syntax element indicates whether the picture requires content owner authorization to be used by the AI engine as an input for any usage.

20. The method of claim 15,
wherein the syntax element comprises a syntax of any of ai_usage_restrictions, aur_cancel_flag, aur_persistence_flag, aur_num_restrictions_minus1, aur_restriction [i], aur_context_present_flag [i], and aur_context [i],
wherein aur_restriction [i] represents any of four values comprising:
a first value indicating “do not use in any AI application”,
a second value indicating “do not use for AI training”,
a third value indicating “do not use for generative (modification or creation) AI”, and
a fourth value indicating “do not use for AI inference”, and
wherein aur_context [i] represents any of:
a first bitMask indicating “commercial use”,
a second bitMask indicating “non-commercial use”,
a third bitMask indicating “official government use”, and
a fourth bitMask indicating “research and academic use”.
